(19) United States
(12) Patent Application Publication
(10) Pub. No.: US 2011/0103043 A1
(43) Pub. Date: May 5, 2011

(54) Device for Supporting Light Emitting Module

(75) Inventors: Kazufusa Ago, Tokyo (JP); Katsunari Tsuji, Tokyo (JP)

(73) Assignee: OPTOWORLD CO., LTD., Tokyo (JP)

(21) Appl. No.: 13/001,580

(22) PCT Filed: Jun. 24, 2009
(86) PCT No.: PCT/JP2009/061463

§ 371 Date: Dec. 27, 2010

(30) Foreign Application Priority Data
Jun. 27, 2008 (JP) 2008-004388

(51) Int. Cl. F21S 8/00

(52) U.S. Cl. 362/147

(57) ABSTRACT

Provided is a supporting device that enables light emitting modules to be easily installed on a ceiling for lighting and is easy to modify the light emitting modules with a simple configuration. For that purpose, a supporting device of the present invention has a large recess groove portion having a width dimension smaller than a dimension of a short side of the light emitting modules and having a length dimension larger than a dimension of a long side of the light emitting modules and a screw fixation portion provided with a threaded hole for fastening on the ceiling. On left and right interior walls of the large recess groove portion, small recess groove portions, parallel to the large recess groove portion, having a cross sectional shape approximately equal to a cross sectional shape of a peripheral end portion of the long side of the light emitting modules are formed in an arrangement facing on the left and right respectively. An interval dimension between facing groove back side portions of the respective small recess groove portion is approximately identical to a dimension of the short side of the light emitting modules.

### TECHNICAL FIELD

The present invention relates to a supporting device in a case of installing a light emitting module having a light emitting element, such as a light emitting diode, arranged on a substrate as a lighting device on a ceiling surface.

### BACKGROUND ART

On a ceiling inside a normal wooden house, a wooden ceiling foundation is formed that is hung with a ceiling hanger from a roofing material, a ceiling hanger receiver, or the like, and a ceiling plate (ceiling board) in a flat plate shape is configured to be fixed thereto with nails, fastening screws, or the like. Materials for the ceiling plate include those based on wood (sawn general lumbers/precious wood, plywood, laminated lumbers, fibrous wood), based on plaster, based on cement (cement boards/rock wool boards), based on plastic, based on metal, based on ceramics/ stone, or the like. Such a ceiling foundation is made by, for example, forming ceiling joist receivers, which are wooden square logs having a cross section in dimensions of 40×40 mm, in parallel within 900 mm and, on the bottom side (interior side), forming ceiling joists in parallel at intervals of 450 mm inside and outside orthogonal to the ceiling joist receivers, or by forming ceiling joists, which are wooden square logs having a cross section in dimensions of 40×50 mm, in a lattice pattern at intervals of 455 mm.

In contrast, on a ceiling inside a light-gauge steel house or on a ceiling inside a structure, such as a heavy-gauge steel building, although the wooden ceiling foundation mentioned above may be formed, since connection with a steel frame is generally easy, a ceiling foundation with light-gauge steel is formed. Such ceiling foundation with light-gauge steel is also referred to as a light ceiling and has a basic configuration similar to the case of a wooden one but all components are formed of thin metal plates.

In a case of configuring a light ceiling, a metal based ceiling foundation that is hung from a roofing material, a ceiling hanger receiver, or the like with hanging bolts (anchor bolts) is formed, and a ceiling plate in a flat plate shape is fixed thereto with fastening screws. A ceiling foundation of a light ceiling is made by, for example, forming ceiling joist receivers, which are light-gauge steel square materials having a lateral opening (C channels) having a cross section in dimensions of 38×12×1.2 mm, in parallel from 900 to 1200 min and, on the bottom side (interior side), forming ceiling joists, which are light-gauge steel square materials having a top opening (M bars) having a cross section in dimensions of 25 (single size, 50 in a case of double size)×19×0.5 mm, in parallel at intervals of 303 mm orthogonal to the ceiling joist receivers. More in detail, between double sized (50×19×0.5 mm in dimensions) ceiling joists (M bars) formed in parallel at intervals of 910 mm, two single sized (25×19×0.5 mm in dimensions) ceiling joists (M bars) are formed in parallel at intervals of 303 mm.

In general since a ceiling-mounted lighting device is relatively heavy, it is fixed on the above mentioned wooden ceiling foundation (ceiling joists or ceiling joist receivers) or ceiling foundation (M bars or C channels) for a light ceiling. In a case of supporting a lighting device with a ceiling plate relatively weak in strength, such as a plaster board, the device may be supported by double ceiling plates. Although lighting devices are normally fixed on ceiling joists, in a case of a heavy lighting device, since a ceiling joist receiver has higher supporting strength than a ceiling joist, it may also be fixed on ceiling joist receivers. In a case of installing a hooking rosette for connecting and supporting a lighting device at the bottom of a ceiling plate, the hooking rosette is fixed on a ceiling joist or a ceiling joist receiver.

On a ceiling inside a high rise building and large scale facilities, a system ceiling is utilized in which suspended T bars in predetermined dimensions of for example, 600 mm in width or 640 mm in width are arranged on a ceiling in a lattice (grid) pattern and a standardized ceiling panel or the like is embedded in each of the lattice pattern. In such a system ceiling, a ceiling is formed by dropping a ceiling panel, for example, in standardized dimensions of 600 mm square into each lattice pattern and supporting the ceiling panels with edge ends hanging out sideways of the T bars. Although lighting on a system ceiling is often installed in place of some of the ceiling panels, it may also be installed by suspending at the bottom of the T bars.

In contrast, regarding a lighting device using a light emitting module having a plurality of light emitting diodes arranged on a substrate as well, there is proposed that a rise in temperature of a light source unit is reduced by, for example, discretely arranging the plurality of light emitting diodes (for example, refer to Patent Document 1). Also there is proposed that a ceiling of a shelf surface is provided with a light emitting module and each of the plurality of light emitting diodes of the light emitting module is provided with a reflection unit in a curved shape (for example, refer to Patent Document 2).

Regarding heat generation of a light emitting module using such a conventional light emitting diode, since light emitting diodes are generally good in efficiency, the heat generation can be made less in a case of obtaining same illuminance compared to incandescent bulbs. However, compared to fluorescent lights in a case of obtaining the same illuminance, light emitting diodes cannot always cut down the amount of heat generation. Also regarding heat generation, since a light emitting diode is generally sealed in a resin package that is low in thermal conductivity and is implemented on a substrate that is low in thermal conductivity, there is a disadvantage that heat is prone to accumulate in the periphery of the light emitting element. In a case of a rise in temperature with a light emitting diode, the lifetime of the element is shortened and the light emitting efficiency is decreased. Therefore, it is proposed to install a heatsink plate or a heatsink piece made of metal to improve the heat dissipation property of the light emitting diode on the substrate or at a midpoint of the substrate, make the substrate itself be a conductive thin plate of metal that is good in thermal conductivity, such as aluminum, or form a through hole, a bump, or a block of copper in the substrate.

The inventor proposes to use a light emitting module subjected to measures to suppress a rise in temperature not limited to the examples mentioned above in place of a conventional fluorescent light. In the light emitting module proposed by the inventor, in a case of, for example, lighting up by applying a rated voltage of 50 Hz, 100 V in a situation where the ambient temperature is at 27 degrees (power consumption 3.14 {W}, total flux 233 {lm}), the temperatures both 60 minutes after and 120 minutes after were at 37 degrees (measurement requested to Tokyo Metropolitan Industrial Technology Research Institute: report number 19 requested optical research Nos. 405 through 407). That is, the light emitting module proposed by the inventor does not rise in temperature higher than 37 degrees in normal use in a case of room temperature at 27 degrees and the electrical power can be cut down greatly. More specifically, the present light emitting module is in dimensions of approximately 250 mm in length×approximately 18.5 mm in width×1.6 mm (3.5 mm including the light emitting diode) in thickness, and in spite of 3.14 {W} in power consumption, it can irradiate the light intensity equivalent to a fluorescent light of 10 {W}. In a case the light intensity of 40 {W} in terms of a fluorescent light, four present modules may be used by connecting in series, in parallel, or the like and the power consumption in that case is only 12.56 {W}, and it is possible to greatly contribute to energy saving.

### Prior Art Documents

### Patent Documents

### Patent Document 1: Japanese Unexamined Patent Publication No. 2005-108519

### Patent Document 2: Japanese Unexamined Patent Publication No. 2008-4296

However, conventionally, there was no supporting device that can easily install standardized light emitting modules for lighting of light emitting diodes on a ceiling formed by fixing ceiling plates on a ceiling foundation with the number of light emitting modules being arbitrarily variable. Therefore, conventionally, it had to use an expensive lighting device for exclusive use having outer dimensions formed by matching in dimensions to enable housing of the light emitting modules, build a supporting device for oneself that is expensive and requires many steps, or modify a mounting device for fluorescent lights for general use into one for light emitting diodes with processing steps and fix it on a ceiling joist or the like with a supporting device for exclusive use. Such conventional devices for supporting light emitting modules are often converted from those for fluorescent lights in general, and therefore they used to have a complex and excessively large structure and excessive strength as those for light emitting modules by having an area surrounding the light emitting portion, other than the outgoing plane, covered with a large thick wood board or the like in order to allow a stabilizer including a transformer unit, such as an inverter, to be placed thereon and protect fluorescent lights damaged easily. Therefore, design modification is also not easy, and the lighting rows of the light emitting modules cannot be easily modified.

### DISCLOSURE OF THE INVENTION

With that, in order to solve the problems mentioned above, it is an object of the present invention to provide a supporting device that can easily install a light emitting module on a ceiling for lighting formed by fixing a ceiling plate on a ceiling foundation and has a simple configuration for easy modification of a number of light emitting modules and replacement thereof.

To solve the problems mentioned above, one aspect of a device for supporting a light emitting module according to the present invention is a device for supporting a light emitting module to install an approximately rectangular light emitting module in a plate shape having predetermined dimensions in length and width as a lighting device on a ceiling formed by fixing a ceiling plate on a ceiling foundation, the supporting device including: a large recess groove portion having a width dimension smaller than a dimension of a short side of the light emitting module and having a length dimension at least larger than a dimension of a long side of the light emitting module; and a screw fixation portion provided with a threaded hole that is arranged on an inner surface or in proximity of the large recess groove portion and through which a screw for fastening on the ceiling perforates leaving a screw head, wherein the large recess groove portion has left and right interior walls formed with small recess groove portions parallel to the large recess groove portion in an arrangement of facing on the left and right respectively in a cross sectional shape approximately equal to a cross sectional shape of a peripheral end portion of the long side of the light emitting module, and an interval dimension between facing groove back side portions of the respective small recess groove portions is approximately identical to the dimension of the short side of the light emitting module.

### BRIEF DESCRIPTION OF THE DRAWINGS

FIG. 1 is a top view and a side view illustrating an outline configuration of a light emitting module used for the present invention.

FIG. 2 are basic configuration diagrams of a supporting device of a first embodiment of the present invention, where 2A is a bottom view of the supporting device alone, 2B is a bottom view in a case of placing light emitting modules on the supporting device, and 2C is an A-A cross sectional view of 2B.

FIG. 3 is a cross sectional view illustrating an outline configuration in a case that the supporting device of the first embodiment of the present invention is installed on a bottom side of a T bar of a system ceiling together with light emitting modules.

FIG. 4 is a cross sectional view illustrating an outline configuration in a case that a supporting device of a second embodiment of the present invention is installed in a ceiling joist (M bar) of a light-gauge steel foundation together with light emitting modules.

FIG. 5 is a cross sectional view illustrating an outline configuration in a case that a supporting device of a third embodiment of the present invention is installed in a ceiling plate 200 together with light emitting modules.

FIG. 6 is a cross sectional view illustrating an outline configuration in a case that a supporting device, embedded in a ceiling plate 200, of a fourth embodiment of the present invention is installed in the ceiling plate 200 together with light emitting modules.

FIG. 7 is a cross sectional view illustrating an outline configuration in a case that a supporting device, embedded in a ceiling plate 200, of a fifth embodiment of the present invention is installed in a ceiling joist (M bar) of a light-gauge steel foundation together with light emitting modules.

FIG. 8 is a cross sectional view illustrating an outline configuration in a case that a supporting device of a sixth embodiment of the present invention is installed in a ceiling joist (M bar) of a light-gauge steel foundation together with a light emitting module.

FIG. 9 is a cross sectional view illustrating an outline configuration in a case that a supporting device, embedded in a ceiling plate 200 of a seventh embodiment of the present invention, is installed in a ceiling joist (M bar) of a light-gauge steel foundation together with a light emitting module.

### DETAILED DESCRIPTION OF THE INVENTION

### Overall Description

In order to solve the problems mentioned above, an embodiment of a device for supporting a light emitting module according to Claim 1 of the present invention is a device for supporting a light emitting module to install an approximately rectangular light emitting module in a plate shape having predetermined dimensions in length and width as a lighting device on a ceiling formed by fixing a ceiling plate on a ceiling foundation, the supporting device including: a large recess groove portion having a width dimension smaller than a dimension of a short side of the light emitting module and having a length dimension at least larger than a dimension of a long side of the light emitting module; and a screw fixation portion provided with a threaded hole that is arranged on an inner surface or in proximity of the large recess groove portion and through which a screw for fastening on the ceiling perforates leaving a screw head, wherein the large recess groove portion has left and right interior walls formed with small recess groove portions parallel to the large recess groove portion in an arrangement of facing on the left and right respectively in a cross sectional shape approximately equal to a cross sectional shape of a peripheral end portion of the long side of the light emitting module, and an interval dimension between facing groove back side portions of the respective small recess groove portions is approximately identical to the dimension of the short side of the light emitting module. According to the present invention of Claim 1, it is possible to easily install a light emitting module on a ceiling for lighting and to have a simple configuration.

Preferably, as the present invention according to Claim 2, the small recess groove portions may also be formed in a rail shape, allowing the peripheral end portion of the long side of the light emitting module to be inserted by sliding from a side face, in left and right interior wall portions of the large recess groove portion. According to the present invention of Claim 2, modification of a light emitting module in the supporting device can be performed easily only by inserting or extracting a light emitting module into or from a recess portion in a rail shape.

Preferably, as the present invention according to Claim 3, the large recess groove portion may also have a side, closer to an opening than at least the respective small recess groove portions of left and right interior wall portions, formed to be a tapered face of a flat or curved surface becoming wider as getting closer to the opening. According to the present invention of Claim 3, with the tapered face of the supporting device, the light outgoing from the light emitting module can be irradiated effectively to the front side.

Preferably, as the present invention according to Claim 4, the screw fixation portion may also be formed by projecting so as to hang out in a direction parallel to an opening plane on an outer side surface on an opening side of the large recess groove portion. According to the present invention of Claim 4, the screw fixation portion of the supporting device can be formed by integral molding.

Preferably, as the present invention according to Claim 5, the supporting device may also include a plurality of rows of the large recess groove portions, and the screw fixation portion may also be formed in at least one middle portion of the plurality of rows of the large recess groove portions. According to the present invention of Claim 5, the middle portion of the plurality of rows in the supporting device can be utilized effectively.

Preferably, as the present invention according to Claim 6, the supporting device may also have a cross sectional shape that can be formed by extrusion molding in a direction along the large recess groove portion and the respective small recess groove portions. According to the present invention of Claim 6, the supporting device can be formed by extrusion molding of metal, a resin, or the like.

Preferably, as the present invention according to Claim 7, on a back surface of the large recess groove portion farther than the respective small recess groove portions, an opening for wiring may also be formed that passes wiring to supply a power source and a light emission control signal to the light emitting module. According to the present invention of Claim 7, the supporting device can facilitate the wiring to supply a power source and a light emission control signal to the light emitting module.

Preferably, as the present invention according to Claim 8, the supporting device may further include a screw to fasten therewith on the ceiling, and the screw may also have a diameter dimension corresponds to the threaded hole of the screw fixation portion and a length dimension equal to or more than a total dimension of a maximum dimension of combining a depth direction dimension from the screw fixation portion and/or a thickness dimension of the ceiling plate, which is at least a depth direction dimension from the screw fixation portion in the supporting device or more, and a thickness dimension of a component screwed together with the screw. According to the present invention of Claim 8, the supporting device can be fixed on a ceiling with a screw.

Preferably, as the present invention according to Claim 9, the ceiling foundation may also be a ceiling foundation using a square material of light-gauge steel, the component screwed together with the screw may also be an indoor side surface portion of the square material, a thickness dimension of the component screwed together with the screw may also be a thickness dimension of the indoor side surface of the square material, and a length dimension of the screw may also be a length dimension equal to or more than a total dimension of a dimension from the screw fixation portion to a backmost portion of the supporting device, the thickness dimension of the ceiling plate, and the thickness dimension of the indoor side of the square material. According to the present invention of Claim 9, the supporting device can be fixed on a light-gauge steel ceiling foundation with a screw.

Preferably, as the present invention according to Claim 10, the component screwed together with the screw may also be a mounting component having a fixing portion formed and arranged to enable to press a non-indoor side of the ceiling plate and provided with a threaded hole screwed together with the screw, the thickness dimension of the component screwed together with the screw may also be a thickness dimension of the mounting component, and the length dimension of the screw may also be a length dimension equal to or more than a total dimension of a dimension from the screw fixation portion to a backmost portion of the supporting device, the thickness dimension of the ceiling plate, and the thickness dimension of the mounting component. According to the present invention of Claim 10, the supporting device can be fixed an arbitrary ceiling plate with a screw.

Preferably, as the present invention according to Claim 11, the ceiling foundation may also be a ceiling foundation using a square material of light-gauge steel, the supporting device may also have a stopper portion formed by projecting so as to hang out in the direction parallel to the opening plane on the outer side surface on the opening side of the large recess groove portion, the component screwed together with the screw may also be an indoor side surface portion of the square material, the thickness dimension of the component screwed together with the screw may also be a thickness dimension of the indoor side of the square material, and a length dimension of the screw may also be a length dimension equal to or more than a total dimension of a dimension from the screw fixation portion to a non-indoor side surface of the ceiling plate and the thickness dimension of the indoor side of the square material. According to the present invention of Claim 11, the supporting device embedded in a ceiling plate fixed on a light-gauge steel ceiling foundation can be fixed with a screw.

Preferably, as the present invention according to Claim 12, the supporting device may also have a stopper portion formed by projecting so as to hang out in the direction parallel to the opening plane on the outer side surface on the opening side of the large recess groove portion, the component screwed together with the screw may also be a mounting component having a fixing portion formed and arranged to enable to press a non-indoor side of the ceiling plate and provided with a threaded hole screwed together with the screw, at least a long side of the fixing portion may also be in a dimension larger than an opening width of the ceiling plate in which the large recess groove portion of the supporting device is embedded, the thickness dimension of the component screwed together with the screw may also be a thickness dimension of the mounting component, and a length dimension of the screw may also be a length dimension equal to or more than a total dimension of a dimension from the screw fixation portion to a non-indoor side surface of the ceiling plate and the thickness dimension of the mounting component. According to the present invention of Claim 12, the supporting device embedded in an arbitrary ceiling plate can be fixed with a screw.

Preferably, as the present invention according to Claim 13, the ceiling foundation may also be a T bar of a system ceiling, the component screwed together with the screw may also be a mounting component arranged inside an edge end portion having a part that hangs out sideways of the T bar and formed of a material that can be screwed together with the screw, the thickness dimension of the component screwed together with the screw may also be approximately equivalent to a thickness dimension of the mounting component arranged inside the edge end portion, and a length dimension of the screw may also be a length dimension approximately equivalent to a total dimension of a dimension from the screw fixation portion to a backmost portion of the supporting device and the thickness dimension of the mounting component. According to the present invention of Claim 13, the supporting device can be fixed on the edge end portion of a T bar on a system ceiling with a screw.

Preferably, as the present invention according to Claim 14, the mounting component may also be in a butterfly nut shape formed inside the edge end portion hanging out sideways of the T bar in a dimension and a shape that can be fixed inside the edge end portion by inserting from an opening in a slit shape on a bottom side of the T bar and making a half turn. According to the present invention of Claim 14, the fixation of the supporting device with a screw on the edge end portion of a T bar on a system ceiling can be made easier further only to make a half turn.

### Effects of the Invention

According to the device for supporting a light emitting module of the present invention, it has a large recess groove portion having a length in a dimension larger than the dimensions of a long side of the light emitting module and the large recess groove portion has left and right interior walls provided with a small recess groove portion into which a long side of the light emitting module is fitted and also provided with a threaded hole to enable fastening with a screw. This enables a device for supporting a light emitting module to be easily installed on an arbitrarily ceiling with a simple configuration and with a light emitting module for lighting. In addition, since the number of light emitting modules on board can be modified only by modifying the dimension in length in the long side direction of the supporting device, a supporting device can be easily manufactured that corresponds to the number of light emitting modules to be used by, for example, cutting a supporting device having a length of several fold or more of the light emitting modules in accordance with the required number or the like.

### DESCRIPTION OF ILLUSTRATED EMBODIMENTS

A detailed description is given below to embodiments of the present invention using the drawings.

<Light Emitting Module>

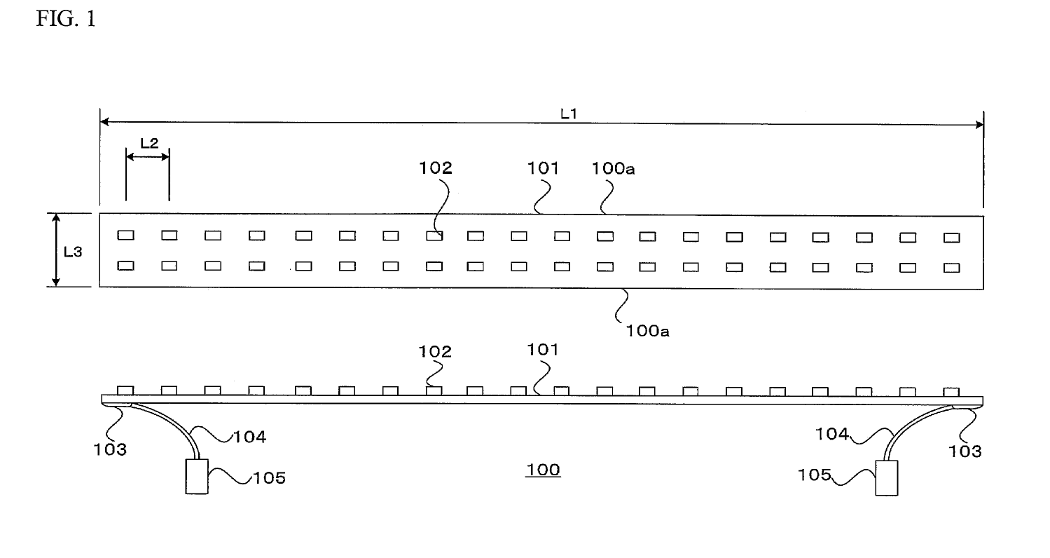

FIG. 1 is a top view and a side view illustrating an outline configuration of a light emitting module used for the present invention.

A light emitting module 100 is in an approximately rectangular plate shape having predetermined length and width dimensions of L1 for the long side and L3 for the short side, in which a plurality of light emitting diodes 102 for lighting are aligned at regular intervals of L2 in series and in two rows on a substrate 101. The intervals between the light emitting diodes 102 are defined by the specification of the light emission intensity and the heat dissipation performance. The arrangement pattern is not limited to the illustrated embodiment.

Advantages in a case of using the light emitting diodes 102 for lighting include, firstly, that it becomes possible to make the light emitting efficiency good and the power consumption less relative to incandescent bulbs. Although it cannot always apply to fluorescent lights because fluorescent lights increase in efficiency as the electrical power increases, at least at tens of watts or less, light emitting diodes can be better in efficiency and make the power consumption less. In addition, accordingly power supply facilities can also be downsized and that the electricity expenses can also be cut down.

Light emitting diodes generally have longer lifetime than incandescent bulbs and fluorescent lights, and replacement expenses can be reduced. An advantage in normal cases, which may also be a disadvantage in some cases, may include that light irradiated from a light emitting diode is directional. Although this property is an advantage in a case that the direction of irradiating the light is limited or irradiation is carried out in one direction, it sometimes becomes a disadvantage in a case that the light is intended to be irradiated in multi-directions including angles other than the directionality or in a case that it is intended to be visually recognized. Disadvantages of light emitting diodes may include that ranges of the voltage and the current in light emission conditions are relatively narrow and they are easily damaged at a voltage or a current in that conditions or more and that those of high brightness for lighting are higher in price.

On the substrate 101, wiring to supply a voltage/current for light emission to each light emitting diode 102 is formed by printing of a conductor pattern, etching after exposure, or the like. The wiring is connected to one end of a lead wire 104 with a connection unit 103 formed on a non-emission surface, and a connector 105 to be connected to an external power supply or the like is mounted at the other end portion of the lead wire 104.

<Basic Configuration of Supporting Device>

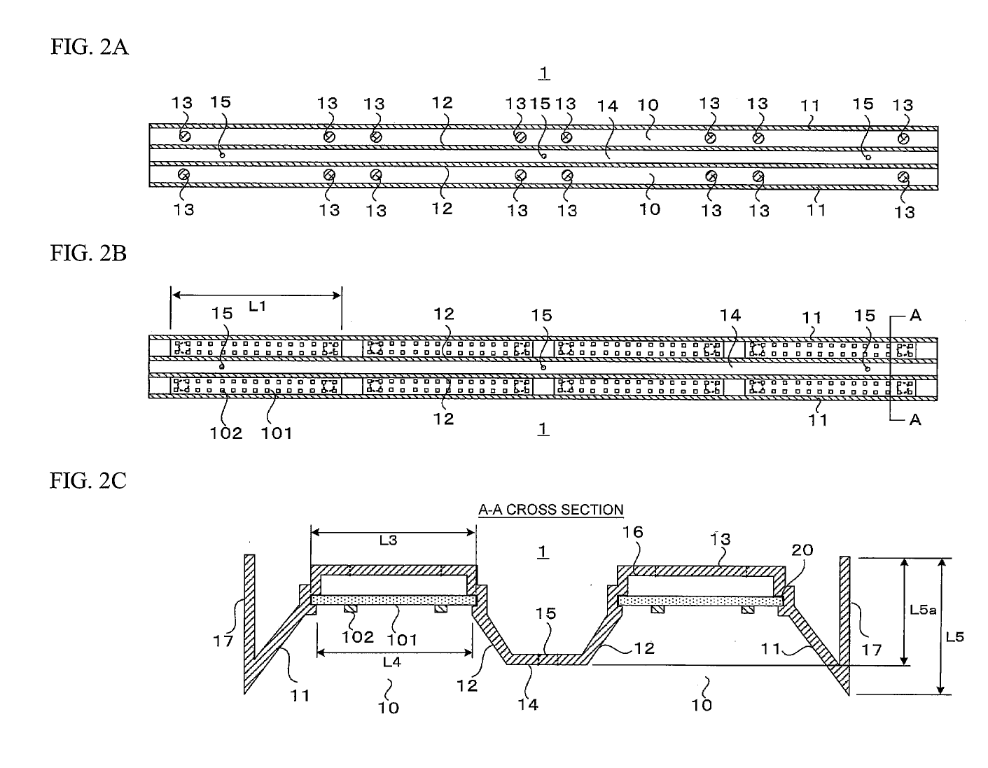

FIG. 2 are basic configuration diagrams of a supporting device of the first embodiment of the present invention. FIG. 2A is a bottom view of the supporting device alone, 2B is a bottom view in a case of placing light emitting modules on the supporting device, and 2C is an A-A cross sectional view of 2B.

A supporting device basic unit 1 of the present embodiment is a device to install light emitting modules 100 in a plate shape and approximately rectangular having predetermined dimensions in length and width as a lighting device on a ceiling formed fixing a ceiling plate 200 described later on a ceiling foundation.

The supporting device basic unit 1 has a large recess groove portion 10 having a width dimension L4 that is smaller than the dimension of a short side L3 of the light emitting modules 100 and a length dimension that is at least larger than the dimension of a long side L1 of the light emitting modules 100, and a screw fixation portion 14 provided with a threaded hole 15 that is arranged in proximity of the large recess groove portion 10 and through which a screw for fastening on the ceiling perforates leaving a screw head. The large recess groove portion 10 may be in an arbitrary shape, such as a rectangular groove, a U shaped groove, or a V shaped groove, as long as it dents in a shape of recess into the back at least larger than the thickness dimension of the light emitting modules 100, has interior wall portions 11 and 12 in the interior to hold the light emitting module 100, and has an opening that can irradiate a light of the light emitting module 100 forward. The supporting device basic unit 1 of the present embodiment has a length dimension of a length that is possible to mount four of the light emitting modules 100 longitudinally (longer than 4× the dimension of the long side L1 of the light emitting modules 100) and has a plurality of rows (two rows) of the large recess groove portions 10.

Openings 13 for wiring are formed on a back surface 16 farther than each small recess groove portion 20 in the large recess groove portion 10, in order to pass the wiring (lead wire) 104 and the connector 105 to supply the power and a light emission control signal to the light emitting modules 100, to be larger than the dimensions of their maximum cross sections.

The screw fixation portion 14 is formed by projecting so as to hang out in the direction parallel to the opening plane on the outer side surface of the opening side of the large recess groove portion 10. In the present embodiment, as there is the plurality of rows of the large recess groove portions 10, it is formed in a middle portion that connects the plurality of rows of the large recess groove portions 10. In a case that the plurality of rows of the large recess groove portions 10 are three or more rows, the screw fixation portion 14 is formed in at least one middle portion. Although the middle portion is formed between end portions on the opening side of each of the interior wall portions 12 of the large recess groove portion 10 in two rows to have the depth dimension of L5a in the present embodiment, it may also be formed at the back end portion or an intermediate portion to the back of the large recess groove portions 10 as long as, for example, a screw and the screw head for fixation can pass between each interior wall portion 12 of the plurality of rows of the large recess groove portions 10.

On each interior wall on the left and right of the large recess groove portion 10, small recess groove portions 20 parallel to the large recess groove portion 10 are formed respectively in an arrangement of facing on the left and right so as to have a cross sectional shape approximately equal to the cross sectional shape of a peripheral end portion 100a of the long side of the light emitting module 100.

The dimension of the intervals between facing groove back side portions of the respective small recess groove portions 20 is approximately identical to the dimension L3 of the short side of the light emitting module 100.

The supporting device basic unit 1 has a cross sectional shape possible to be formed by extrusion molding in the direction along the large recess groove portion 10 and each small recess groove portions 20. The supporting device basic unit 1 can be fabricated, for example, by molding a cold-rolled sheet steel (SPC material) or fabricated by extrusion molding of aluminum. The SPC material may also be processed using a pressing apparatus or the like used for general machining process. The extrusion processing of an aluminum material may also be hot processing that extrudes at a high pressure using a pressing apparatus and molds (dies) or the like used for a general machining process. Each small recess groove portion 20 is formed in a rail shape (perforating between both ends of the long side of the supporting device basic unit 1) possible to insert the peripheral end portion 100a of the long side of the light emitting modules 100 into the left and right interior wall portions 11 and 12 of the large recess groove portion 10 by sliding from the side face. The light emitting modules 100 are arranged between respective facing small recess groove portions 20 in a rail shape by directing the light emitting diodes 102 to the open portion side. In a case that the substrate 101, the printed wiring, and the like of the light emitting module 100 have sufficient flexibility (not generating a crack, a fracture, or the like when bent etc.), the light emitting modules 100 may also be arranged between the respective small recess groove portions 20 by pushing them from the opening side instead of inserting them by sliding from the side face. In that case, each small recess groove portion 20 is not necessary to be in a rail shape perforating between both ends of the long side of the supporting device basic unit 1, but it may be a recess portion in a shape matching the peripheral end portion 100a of the long side of the light emitting module 100.

In each of the left and right interior wall portions 11 and 12 of the large recess groove portion 10, the side closer to the opening than each small recess groove portion 20 is formed to be a tapered face of a flat or curved surface having a wider opening width as getting closer to the opening. This enables the light outgoing from the light emitting module 100 to be reflected to the front side. For example, in a case that the irradiation angle of the light emitting diodes 102 of the light emitting module 100 is at 110 degrees, the side closer to the opening than each small recess groove portion 20 in the respective interior wall portions 11 and 12 is formed at an angle possible to reflect forward the left and right (reflective surfaces on both sides) end portions of the outgoing light spanning 110 degrees.

The interior wall portion 11 is provided with an exterior wall portion 17 at the end portion on the opening side. The exterior wall portion 17 is formed outside the interior wall portions 11 so as to cover a side wall of the long side of the supporting device basic unit 1. The exterior wall portion 17 also has a function as a spacer to secure a space to the ceiling on the back side thereof allowing wiring of the lead wire 104 and the like coming out of the opening 13 for wiring to the back side of the supporting device basic unit 1 without being pressed. Therefore, the depth side dimension L5 of the exterior wall portion 17 is larger than the depth side dimension from the opening plane of the large recess groove portion 10 to the opening 13 for wiring.

In such a manner, in the supporting device basic unit 1, modification of the light emitting modules 100 can be easily performed only by inserting or extracting the light emitting modules 100 into or from the small recess groove portions 20 in a rail shape, and the light outgoing from the light emitting modules 100 can be irradiated effectively to the front side by reflecting it on the reflective surface portions 11 and 12.

### First Embodiment

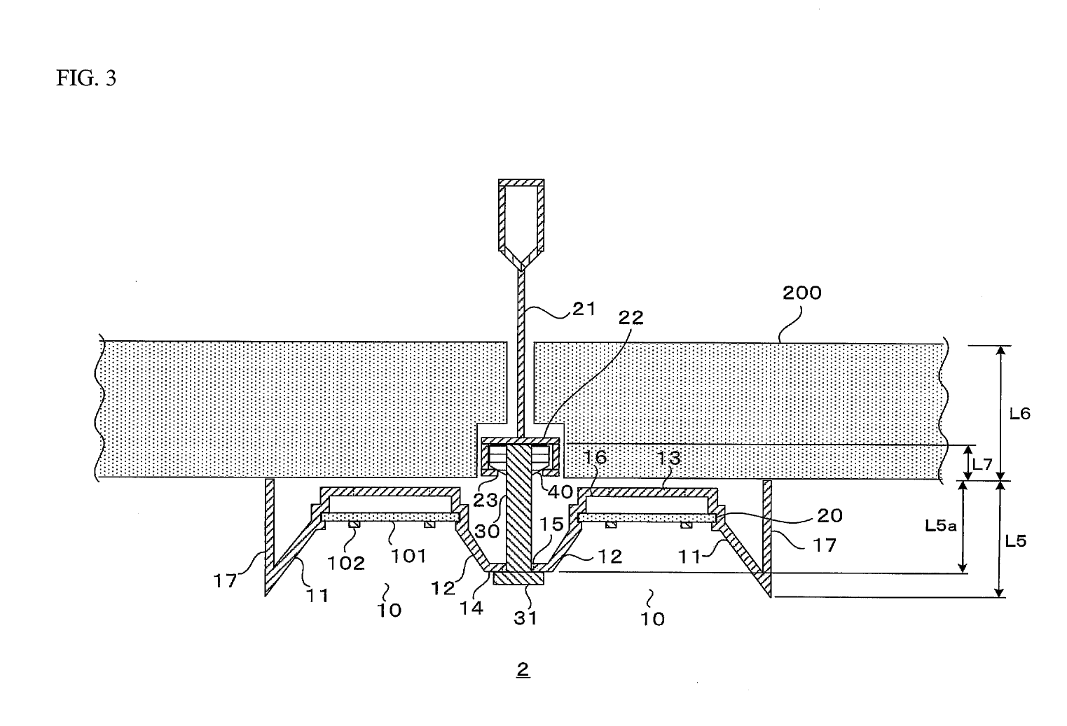

FIG. 3 is a cross sectional view illustrating an outline configuration in a case that the supporting device of the first embodiment of the present invention is installed on the bottom side of a T bar on a system ceiling together with the light emitting modules.

T bars 21 are suspended from a roof, an upstairs floor, or the like, are installed vertically and horizontally in parallel in predetermined dimensions, such as 600 mm or 640 mm, and are frame components to form a ceiling by dropping the ceiling plates 200 in standardized dimensions, such as 600 mm×600 mm. An edge end portion 22 is a part at an edge end hanging out sideways of the T bar 21. The system ceiling is in predetermined dimensions, such as 600 mm or 640 mm, as mentioned above, and a grid in which the T bars 21 in parallel are arranged vertically and horizontally in a lattice pattern is formed. Accordingly, the intervals between the T bars 21 in parallel are also in a predetermined dimension, such as 600 mm or 640 mm. The system ceiling may also be installed in a predetermined dimension, such as 300 mm, 900 mm, or 1800 mm.

A power supply unit (not shown) is connected directly or indirectly to the connector 105 of each light emitting module 100 on one side and connected to a commercial power supply (100 V, 200 V, or the like) on the other side to supply a rated voltage/rated current (for example, 24 V/130 mA, or the like) of each light emitting module 100 by transforming the voltage using an inverter or the like.

A supporting device 2 is configured with, in addition to the supporting device basic unit 1 illustrated in FIG. 2, a screw 30 having a head 31 and having dimensions possible to be inserted into the threaded hole 15 of the screw fixation portion 14, and a mounting component 40 possible to screw together with the screw 30 and arranged inside the edge end portion 22. The mounting component 40 is a component screwed together with the screw 30, is arranged inside the edge end portion 22 having a portion hanging out sideways of the T bar 21, and is formed with a material and in a shape that enable to screw together with the screw 30 and to fix the screwed portion inside the edge end portion 22. For example, the mounting component 40 is wood, a polymer material, or the like that allows fixation (tapping) while forming a screw thread with the screw 30, and it may also be inserted or filled inside the edge end portion 22. The screw 30 in that case may be, for example, a tapping screw that can be fixed while forming a thread groove in the mounting component 40.

As another example, the mounting component 40 is, for example, in a butterfly nut shape, and is formed in dimensions and a shape that can be fixed inside the edge end portion 22 by, for example, inserting inside the edge end portion 22 hanging out sideways of the T bar 21 from an opening 23 in a slit shape on a bottom side of the T bar 21 and by making a half turn. The component screwed together with the screw 30 has a thickness dimension approximately equivalent to a thickness dimension L7 of the mounting component 40 arranged inside the edge end portion 22, and the screw 30 has a length dimension approximately equivalent to a total dimension of the dimension L5a from the screw fixation portion 14 to the backmost portion of the supporting device basic unit 1 and the thickness dimension L7 of the mounting component 40.

In a case of using the supporting device 2 of the present embodiment installed on a system ceiling, when replacing the light emitting module 100, the screw 30 is removed from the edge end portion 22 of the T bar 21 by, for example, turning the head 31 of the screw 30 with a driver or the like to remove the connector 105 coming out on the back side of the supporting device basic unit 1 from the connection with the power supply unit. In a case that the mounting component 40 is in a butterfly nut shape, a projecting portion of the butterfly nut is made in parallel to the opening 23 in a slit shape by a ¼ rotation (90 degrees rotation) while pressing. In such a manner, the screw 30 and the mounting component 40 may also be removed from the edge end portion 22 of the T bar 21.

Then, the light emitting module 100 to be replaced is taken out of the end portion of the long side of the supporting device basic unit 1 by sliding in a direction along each small recess groove portion 20 (or the long side) and a new light emitting module 100 is inserted in place to be arranged at a predetermined position of the supporting device basic unit 1. After that, the new light emitting module 100 is connected to the connector and the head 31 of the screw 30 is turned with a driver or the like to mount the screw 30 in the edge end portion 22 of the T bar 21. In a case that an end plate (not shown) is mounted at an end portion of the long side of the supporting device basic unit 1, the process of replacing the light emitting module 100 mentioned above is performed after removing the end plate. In a case of intending to reduce the illuminance, a blindfold plate for filling the space or the like may also be installed in place of the light emitting module 100.

In such a manner, in the supporting device 2 of the present embodiment, the light emitting modules 100 can be installed easily for lighting with a screw in the edge end portion 22 of the T bar 21 on a system ceiling, and the replacement of the light emitting module 100 can be performed with a simple configuration. By making the mounting component 40 in a butterfly nut shape, the fixation of the supporting device with a screw on the edge end portion of the T bar on a system ceiling can further be made easier only to make a half turn.

### Second Embodiment

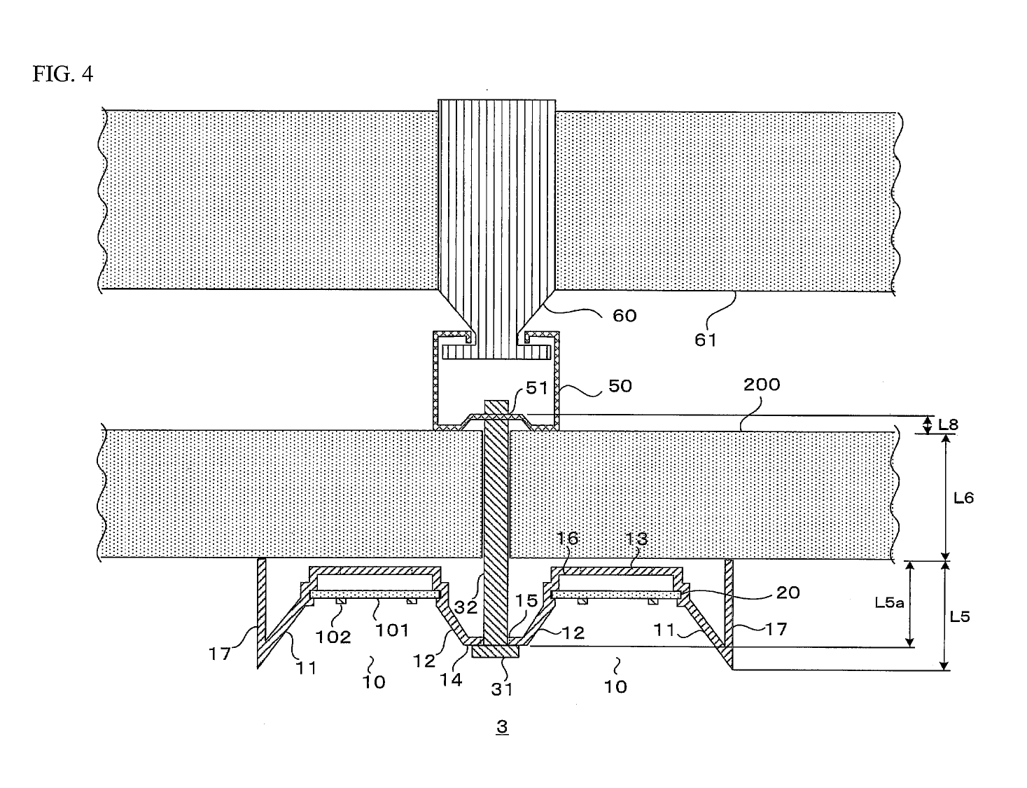

FIG. 4 is a cross sectional view illustrating an outline configuration in a case of installing a supporting device of the second embodiment of the present invention in a ceiling joist (M bar) of a light-gauge steel foundation together with light emitting modules. An M bar 50 of a light-gauge steel foundation is a square material having a cross section of an approximate square shape and having an opening on the top side, and is fixed on a ceiling joist receiver 61 with a clip 60. The M bar 50 and the clip 60 are available in a single size (25 mm in width) and a double size (50 mm in width), and a supporting device 3 of the present embodiment is possible to install in either size.

The supporting device 3 is configured with, in addition to the supporting device basic unit 1 illustrated in FIG. 2, in order to install the light emitting modules 100 on a ceiling of a light-gauge steel foundation (light ceiling), a screw 32 in which the length dimension of the screw 30 of the first embodiment, for example, is extended longer than a lower surface 51, which is an indoor side portion of the M bar 50, through the ceiling plate 200 so as to enable fixation on the M bar 50 of the light-gauge steel foundation. In FIG. 4, the thickness dimension of the lower surface 51 on the indoor side surface in the M bar 50 screwed together with the screw 32 is L8. The screw 32 of the present embodiment may be, for example, a tapping screw that can be fixed while forming a thread groove on the lower surface 51 of the M bar 50 by perforating the ceiling plate 200. When the position of the M bar 50 is known in a case that the M bar 50 is positioned at the border portion of the ceiling plate 200 or the like, a thread groove for a nut may also be formed in advance in the lower surface 51 of the M bar 50, for example, and a normal screw, a bolt, or the like may be used as the screw 32.

The screw 32 has a length dimension equal to or more than a total dimension of the dimension L5a from the screw fixation portion 14 to the backmost portion of the supporting device basic unit 1 of FIG. 2, a thickness dimension L6 of the ceiling plate 200, and a thickness dimension L8 of the lower surface 51 (indoor side surface) in the M bar 50.

In a case of using the supporting device 3 of the present embodiment for the light-gauge steel foundation when replacing the light emitting module 100, the screw 32 is removed from the lower surface 51 of the M bar 50 by, for example, turning the head 31 of the screw 32 with a driver or the like, and the connector 105 coming out on the back side of the supporting device basic unit 1 is removed from the connection with the power supply unit.

Then, the light emitting module 100 to be replaced is taken out of an end portion of the long side of the supporting device basic unit 1 by sliding in the direction along each small recess groove portion 20 (or the long side), and a new light emitting module 100 is inserted in place to be arranged at a predetermined position of the supporting device basic unit 1. After that, the new light emitting module 100 is connected to the connector, and the screw 32 is mounted in the lower surface 51 of the M bar 50 by turning the head 31 of the screw 32 with a driver or the like. In a case that an end plate (not shown) is mounted at an end portion of the long side of the supporting device basic unit 1, the process of replacing the light emitting module 100 mentioned above is performed after removing the end plate. In a case of intending to reduce the illuminance, a blindfold plate for filling the space or the like may also be installed in place of the light emitting module 100.

In such a manner, in the supporting device 3 of the present embodiment, using the light emitting modules 100 for lighting, the supporting device 3 can be fixed easily with the screw 32 on the lower surface 51 of the M bar 50 of the light-gauge steel foundation. Replacement of the light emitting modules 100 can be performed easily with a simple configuration.

### Third Embodiment

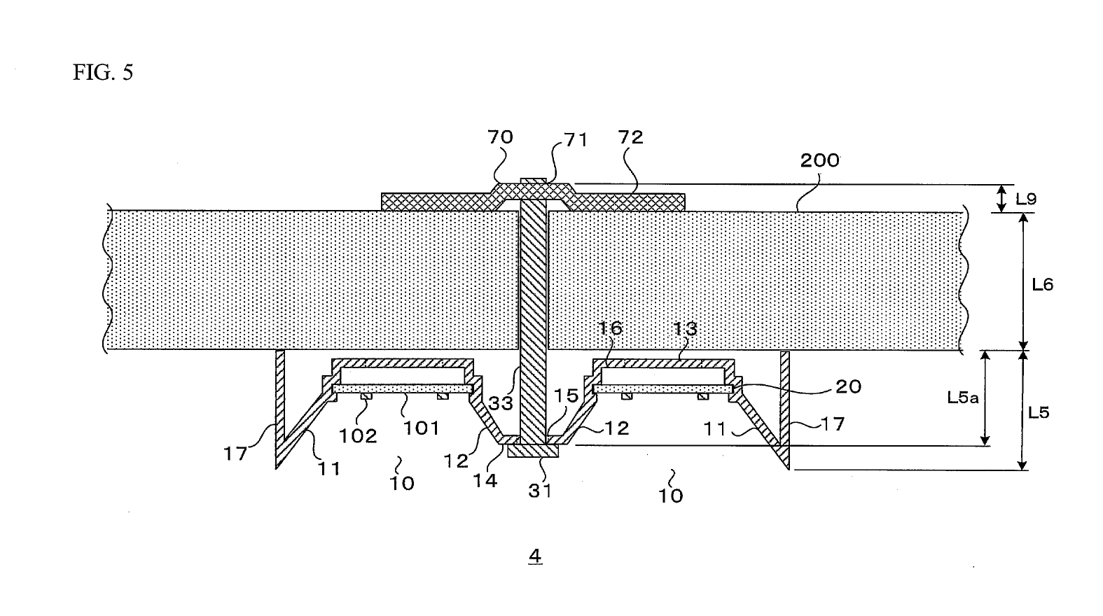

FIG. 5 is a cross sectional view illustrating an outline configuration in a case that a supporting device of the third embodiment of the present invention is installed in the ceiling plate 200 together with the light emitting modules.

A device supporting 4 is configured with, in addition to the supporting device basic unit 1 illustrated in FIG. 2, in order to install the light emitting modules 100 on the ceiling plate 200 having an arbitrary thickness dimension, a screw 33 in which the length dimension of the screw 30 of the first embodiment, for example, is extended to a roof side of the ceiling plate 200 so as to enable fixation on the ceiling plate 200. A mounting component 70 has a fixing portion 72 screwed together with the screw 33 in FIG. 5 and formed and arranged to enable to press a non-indoor side (roof side) of the ceiling plate 200, and is provided with a threaded hole 71 screwed together with the screw 33.

In the mounting component 70, the thickness dimension of the mounting component 70 screwed together with the screw 33 is a dimension shown as L9 in FIG. 5, and the screw 33 of the present embodiment may be a tapping screw, for example, a tapping screw that can be fixed while forming a thread groove on the mounting component 70 by perforating the ceiling plate 200. When the position of the mounting component 70 is known in a case that the mounting component 70 is positioned at the border portion of the ceiling plate 200 or the like, a thread groove for a nut may also be formed in advance in the mounting component 70, for example, and a normal screw, a bolt, or the like may be used as the screw 33.

The screw 33 has a length dimension equal to or more than a total dimension of the dimension L5a from the screw fixation portion 14 to the backmost portion of the supporting device basic unit 1 of FIG. 2, a thickness dimension L6 of the ceiling plate 200, and a thickness dimension L9 of the mounting component 70.

In a case of using the supporting device 4 of the present embodiment when replacing the light emitting module 100, the screw 33 is removed from the mounting component 70 by, for example, turning the head 31 of the screw 33 with a driver or the like, and the connector 105 coming out on the back side of the supporting device basic unit 1 is removed from the connection with the power supply unit.

Then, the light emitting module 100 to be replaced is taken out of an end portion of the long side of the supporting device basic unit 1 by sliding in the direction along each small recess groove portion 20 (or the long side), and a new light emitting module 100 is inserted in place to be arranged at a predetermined position of the supporting device basic unit 1. After that, the new light emitting module 100 is connected to the connector, and the screw 33 is mounted in the mounting component 70 on a roof side face of the ceiling 200 by turning the head 31 of the screw 33 with a driver or the like. In a case that an end plate (not shown) is mounted at an end portion of the long side of the supporting device basic unit 1, the process of replacing the light emitting module 100 mentioned above is performed after removing the end plate. In a case of intending to reduce the illuminance, a blindfold plate for filling the space or the like may also be installed in place of the light emitting module 100.

In such a manner, in the supporting device 4 of the present embodiment, using the light emitting modules 100 for lighting, the supporting device 4 embedded in an arbitrary ceiling plate can be fixed easily with the screw 33 on the ceiling plate 200, and replacement of the light emitting modules 100 can be performed easily with a simple configuration.

### Fourth Embodiment

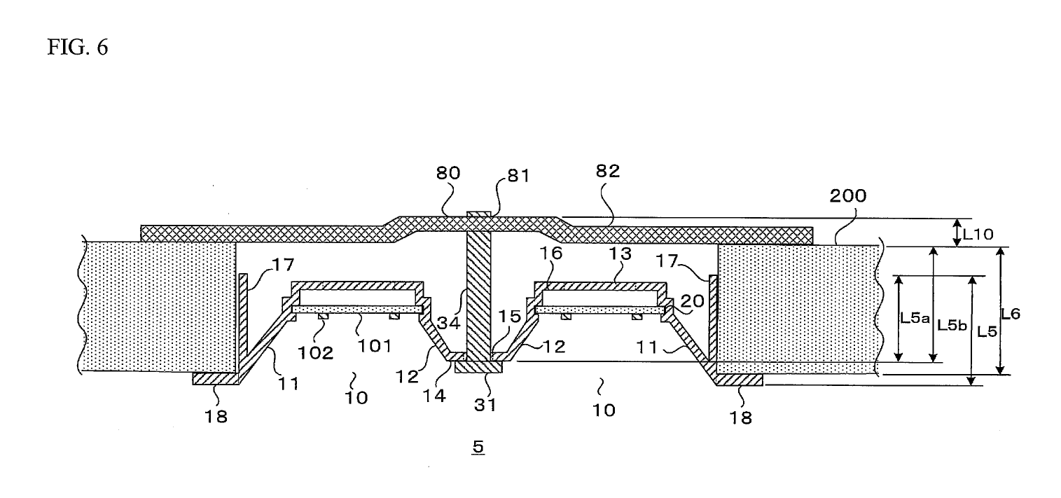

FIG. 6 is a cross sectional view illustrating an outline configuration in a case that a supporting device of the fourth embodiment of the present invention is installed in the ceiling plate 200 together with the light emitting modules.

In a supporting device 5, stopper portions 18 are formed by projecting so as to hang out in a direction parallel to the opening plane on the outer side surfaces of the end portions on the opening side of the interior wall portions 11 of the supporting device basic unit 1 illustrated in FIG. 2. The stopper portions 18 are stoppers to prevent the large recess groove portions 10 from embedded completely in a case of embedding the large recess groove portions 10 of the supporting device 5 in an opening in the ceiling plate 200.

The supporting device 5 is configured with, in addition to the supporting device basic unit with the stopper portion 18 added thereto, in order to install the light emitting modules 100 by embedding them in the ceiling plate 200 having a thickness dimension thicker than the depth dimension of the supporting device 5, a screw 34 in which the length dimension of the screw 30 of the first embodiment, for example, is extended to a roof side of the ceiling plate 200 so as to enable fixation on the ceiling plate 200. It should be noted that, in the fourth embodiment, to embed the supporting device 5 in the ceiling plate 200, only a part of the thickness dimension L6 of the ceiling plate 200 may be added in the length dimension of the screw 34.

A mounting component 80 has a fixing portion 82 screwed together with the screw 34 in FIG. 6 and formed and arranged to enable to press a non-indoor side (roof side) of the ceiling plate 200, and is provided with a threaded hole 81 screwed together with the screw 34. At least the long side of the fixing portion 82 has a dimension larger than the opening width of the ceiling plate 200 in which the large recess groove portions 10 of the supporting device 5 are embedded.

In the mounting component 80, the thickness dimension of the mounting component 80 screwed together with the screw 34 is in a dimension shown as L10 in FIG. 6, and the screw 34 of the present embodiment may be a tapping screw, for example, a tapping screw that can be fixed while forming a thread groove 81 on the mounting component 80. When the position of the mounting component 80 is known in a case that the mounting component 80 is positioned at the border portion of the ceiling plate 200 or the like, a thread groove for a nut may also be formed in advance in the mounting component 80, for example, and a normal screw, a bolt, or the like may be used as the screw 40.

The screw 34 has a length dimension equal to or more than a total dimension of the dimension L5b from the screw fixation portion 14 to the non-indoor side (roof side) of the ceiling plate 200 and a thickness dimension L10 of the mounting component 80.

In a case of using the supporting device 4 of the present embodiment when replacing the light emitting module 100, the screw 34 is removed from the mounting component 80 by, for example, turning the head 31 of the screw 34 with a driver or the like, and the connector 105 coming out on the back side of the supporting device basic unit 1 is removed from the connection with the power supply unit.

Then, the light emitting module 100 to be replaced is taken out of an end portion of the long side of the supporting device basic unit 1 by sliding in the direction along each small recess groove portion 20 (or the long side), and a new light emitting module 100 is inserted in place to be arranged at a predetermined position of the supporting device basic unit 1. After that, the new light emitting module 100 is connected to the connector 105, and the screw 34 is mounted in the mounting component 80 on a roof side face of the ceiling 200 by turning the head 31 of the screw 34 with a driver or the like. In a case that an end plate (not shown) is mounted at an end portion of the long side of the supporting device basic unit 1, the process of replacing the light emitting module 100 mentioned above is performed after removing the end plate. In a case of intending to reduce the illuminance, a blindfold plate for filling the space or the like may also be installed in place of the light emitting module 100.

In such a manner, in the supporting device 5 of the present embodiment, using the light emitting modules 100 for lighting, the supporting device 4 embedded in an arbitrary ceiling plate 200 can be fixed easily with the screw on the ceiling plate 200. Replacement of the light emitting modules 100 can be performed easily with a simple configuration. In addition, since the amount of projection on the indoor face side of the ceiling plate 200 can be decreased in the present embodiment, the appearance of indoor lighting can be made well.

### Fifth Embodiment

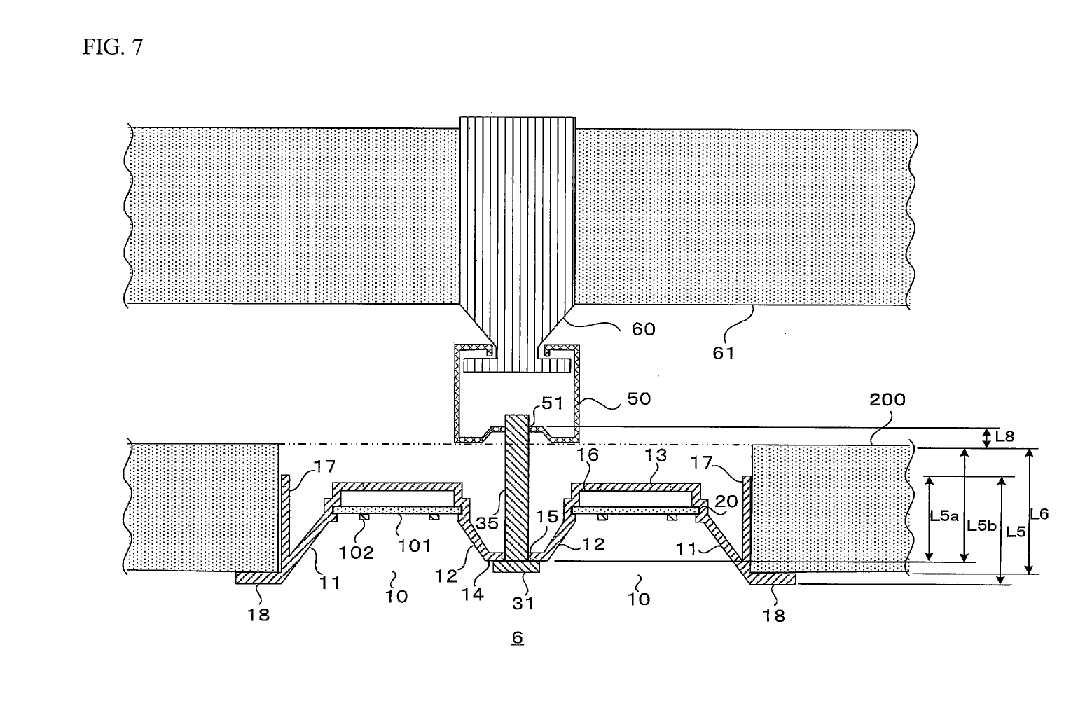

FIG. 7 is a cross sectional view illustrating an outline configuration in a case that a supporting device of the fifth embodiment of the present invention is installed in a ceiling joist (M bar) of a light-gauge steel foundation together with light emitting modules.

The M bar 50 of the light-gauge steel foundation is omitted from the description as it is described in the second embodiment. In a supporting device 6, stopper portions 18 are formed by projecting so as to hang out in a direction parallel to the opening plane on the outer side surfaces of the end portions on the opening side of interior wall portions 11 of the supporting device basic unit 1 illustrated in FIG. 2.

The stopper portions 18 are stoppers to prevent the large recess groove portions 10 from embedded completely in a case of embedding the large recess groove portions 10 of the supporting device 5 in an opening in the ceiling plate 200. The supporting device 6 is configured with, in addition to the supporting device basic unit with the stopper portion 18 added thereto, in order to install the light emitting modules 100 by embedding them in the ceiling plate 200 having a thickness dimension thicker than the depth dimension of the supporting device 5, a screw 35 in which the length dimension of the screw 30 of the first embodiment, for example, is extended to a roof side of the ceiling plate 200 so as to enable fixation on the ceiling plate 200. It should be noted that, in the fifth embodiment, to embed the supporting device 6 in the ceiling plate 200, the thickness dimension L6 of the ceiling plate 200 may be considered as a dimension only a part of which is added in the length dimension of the screw 35.

The thickness dimension of the lower surface 51 on the indoor side surface of the M bar 50 screwed together with the screw 35 in FIG. 7 is set to be L8 similar to the second embodiment. The screw 35 of the present embodiment may be, for example, a tapping screw that can be fixed while forming a thread groove on the lower surface 51 of the M bar 50. When the position of the M bar 50 is known in a case that the M bar 50 is positioned at the border portion of the ceiling plate 200 or the like, a thread groove for a nut may also be formed in advance in the lower surface 51 of the M bar 50, for example, and a normal screw, a bolt, or the like may be used as the screw 35.

The screw 35 has a length dimension, the screw 35 has a length dimension equal to or more than a total dimension of the dimension L5b from the screw fixation portion 14 to the non-indoor side (roof side) of the ceiling plate 200 and the thickness dimension L8 of the lower surface 51 (indoor side surface) in the M bar 50.

In a case of using the supporting device 3 of the present embodiment for the light-gauge steel foundation when replacing the light emitting module 100, the screw 35 is removed from the lower surface 51 of the M bar 50 by, for example, turning the head 31 of the screw 35 with a driver or the like, and the connector 105 coming out on the back side of the supporting device basic unit 1 is removed from the connection with the power supply unit.

Then, the light emitting module 100 to be replaced is taken out of an end portion of the long side of the supporting device basic unit 1 by sliding in the direction along each small recess groove portion 20 (or the long side), and a new light emitting module 100 is inserted in place to be arranged at a predetermined position of the supporting device basic unit 1. After that, the new light emitting module 100 is connected to the connector, and the screw 35 is mounted in the lower surface 51 of the M bar 50 by turning the head 31 of the screw 35 with a driver or the like. In a case that an end plate (not shown) is mounted at an end portion of the long side of the supporting device basic unit 1, the process of replacing the light emitting module 100 mentioned above is performed after removing the end plate. In a case of intending to reduce the illuminance, a blindfold plate for filling the space or the like may also be installed in place of the light emitting module 100.

In such a manner, in the supporting device 6 of the present embodiment, the light emitting modules 100 can be installed easily for lighting in the lower surface 51 of the M bar 50 of the light-gauge steel foundation, the supporting device 6 embedded in the ceiling plate 200 can be fixed on the light-gauge steel ceiling foundation with the screw 35. Replacement of the light emitting modules 100 can be performed easily with a simple configuration. In addition, since the amount of projection on the indoor face side of the ceiling plate 200 can be decreased in the present embodiment, the appearance of indoor lighting can be made well.

### Sixth Embodiment

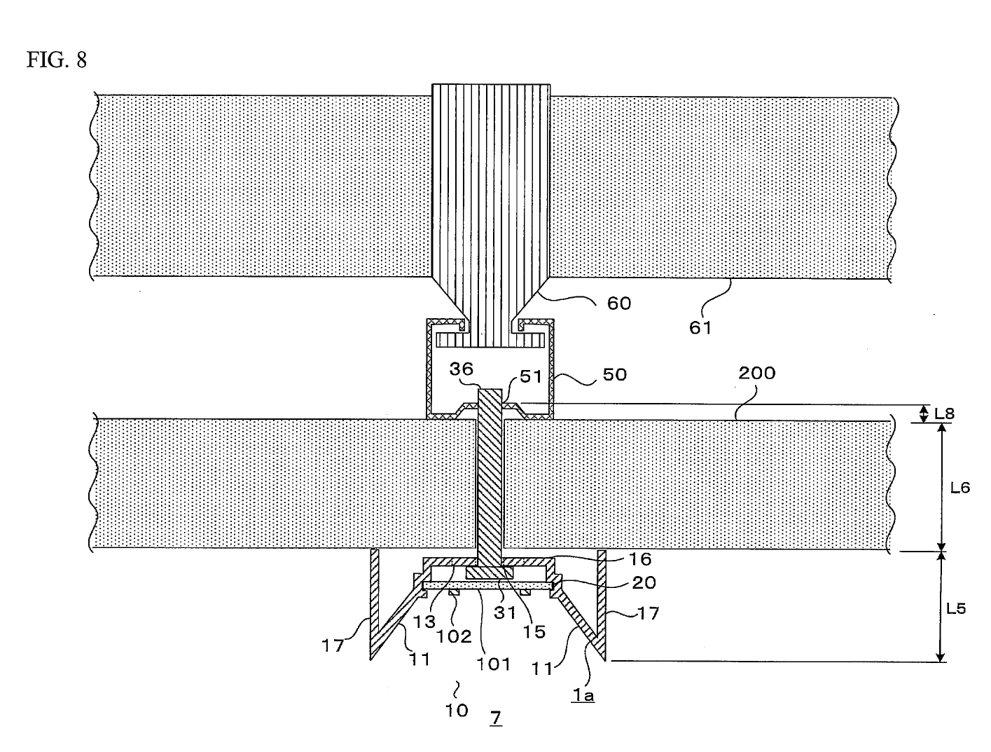

FIG. 8 is a cross sectional view illustrating an outline configuration in a case that a supporting device of the sixth embodiment of the present invention is installed in a ceiling joist (M bar) of a light-gauge steel foundation together with the light emitting modules. A supporting device 7 of the present embodiment is different in a point of enabling to support only one row, whereas the supporting device 3 of the second embodiment is enabled to support two rows of the light emitting modules 100.

The supporting device 7 is configured with, in addition to a supporting device basic unit 1a of supporting one row, which is different from the supporting device basic unit 1 of supporting two rows illustrated in FIG. 2, a screw 36 that is extended longer than the lower surface 51, which is an indoor side portion of the M bar 50, through the ceiling plate 200 so as to enable fixation of the light emitting modules 100 on the M bar 50 of the light-gauge steel foundation. Although other dimensions, methods of installation/replacement, and the like are basically similar to the case of the second embodiment illustrated in FIG. 4, the screw 36 for mounting viewed from the bottom side may also be arranged between the respective light emitting modules 100.

In such a manner, in the supporting device 7 of the present embodiment, using the light emitting modules 100 in one row for lighting, the supporting device 7 can be fixed easily with the screw 36 on the lower surface 51 of the M bar 50 of the light-gauge steel foundation. Replacement of the light emitting modules 100 can be performed easily with a simple configuration. It should be noted that the supporting device for the light emitting modules 100 in one row of the present embodiment can be mounted on a ceiling not having the M bar 50 by being combined with another embodiment mentioned above.

### Seventh Embodiment

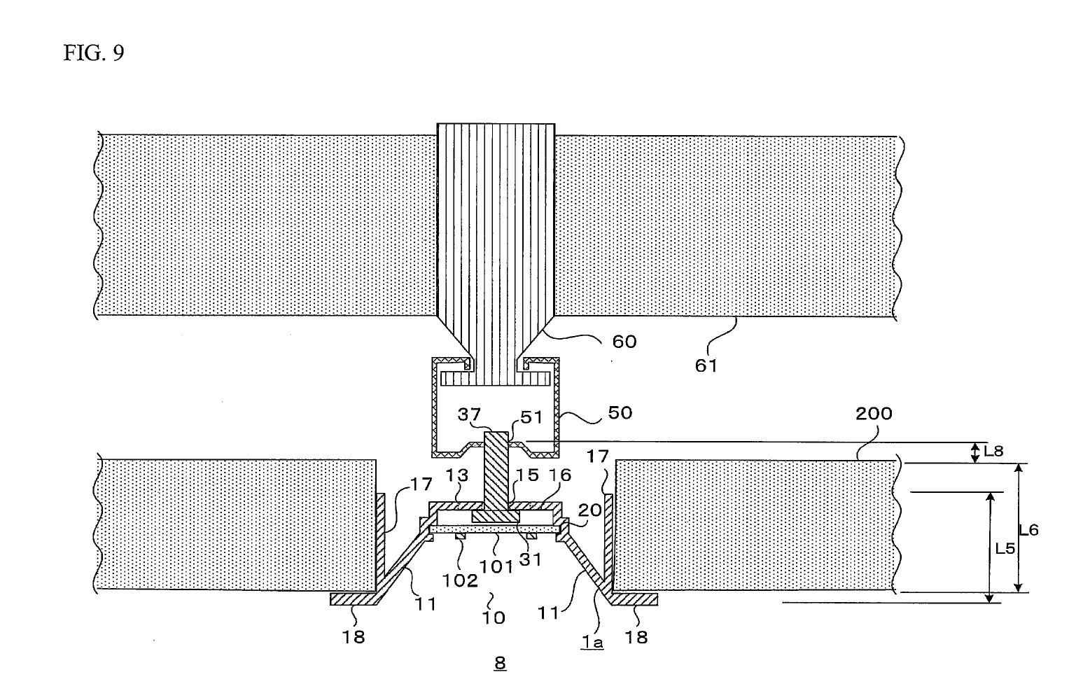

FIG. 9 is a cross sectional view illustrating an outline configuration in a case that a supporting device of the seventh embodiment of the present invention is installed in a ceiling joist (M bar) of a light-gauge steel foundation together with the light emitting modules. In a supporting device 8 of the present embodiment, stopper portions 18 are formed by projecting so as to hang out in a direction parallel to the opening plane on the outer side surfaces of the end portions on the opening side of interior wall portions 11 of the supporting device basic unit 1a illustrated in FIG. 8.

The stopper portions 18 are similar to those of the fifth embodiment. The supporting device 8 is configured with, in addition to the supporting device basic unit with the stopper portion 18 added thereto, in order to install the light emitting modules 100 by embedding them in the ceiling plate 200 having a thickness dimension thicker than the depth dimension of the supporting device 8, a screw 37 extended to a roof side of the ceiling plate 200. It should be noted that, in the seventh embodiment, to embed the supporting device 8 in the ceiling plate 200, the thickness dimension L6 of the ceiling plate 200 may be considered as a dimension only a part of which is added in the length dimension of the screw 35. Although other dimensions, methods of installation/replacement, and the like are basically similar to the case of the fifth embodiment illustrated in FIG. 7, the screw 37 for mounting viewed from the bottom side may also be arranged between the respective light emitting modules 100.

In such a manner, in the supporting device 8 of the present embodiment, the light emitting modules 100 in one row for lighting can be installed easily for lighting in the lower surface 51 of the M bar 50 of the light-gauge steel foundation, the supporting device 8 embedded in the ceiling plate 200 can be fixed on the light-gauge steel ceiling foundation with the screw 37. Replacement of the light emitting modules 100 can be performed easily with a simple configuration. In addition, since the amount of projection on the indoor face side of the ceiling plate 200 can be decreased in the present embodiment, the appearance of indoor lighting can be made well. It should be noted that the supporting device for the light emitting modules 100 in one row of the present embodiment can be mounted on a ceiling not having the M bar 50 by being combined with another embodiment mentioned above.

Although the device for supporting a light emitting module according to the present invention has been described above using the embodiments, the technical scope of the present invention is not limited to the range of the supporting devices according to the embodiments mentioned above. As long as being a unit in a plate shape for supporting a light emitting module 100 having an opening for wiring or a unit in a plate shape for supporting a light emitting module 100 by sandwiching the side faces, it is applicable to devices of configurations other than the above. In addition, the device for supporting a light emitting module according to the present invention may also be provided with a mounting hole, a groove, or the like on the reflective surface to mount a louver and may also be provided with a mounting hole, a groove, or the like on the reflective surface or on the outer periphery to mount an acrylic cover.

### EXPLANATION Of REFERENCE NUMBER

1, 1a supporting device basic unit
2, 3, 4, 5, 6 supporting device
10 large recess groove portion
11,12 interior wall portion
13 opening for wiring
14 screw fixation portion
15 threaded hole
16 back surface
17 exterior wall portion
18 stopper portion
20 small recess groove portion
21 T bar
22 edge end portion
23 opening (in a slit shape)
30, 32, 33, 34, 35 screw
31 head
40 mounting component
50 M bar
51 lower surface
60 clip
61 ceiling joist receiver
70, 80 mounting component
71, 81 threaded hole
72, 82 fixing portion
100 light emitting module
100a peripheral end portion
101 substrate
102 light emitting diode
103 connection unit
104 lead wire
105 connector
200 ceiling plate

1. A device for supporting a light emitting module to install an approximately rectangular light emitting module in a plate shape having predetermined dimensions in length and width as a lighting device on a ceiling formed by fixing a ceiling plate on a ceiling foundation, the device comprising:
a large recess groove portion having a width dimension smaller than a dimension of a short side of the light emitting module and having a length dimension at least larger than a dimension of a long side of the light emitting module; and
a screw fixation portion provided with a threaded hole that is arranged on an inner surface or in proximity of the large recess groove portion and through which a screw for fastening on the ceiling perforates leaving a screw head, wherein
the large recess groove portion has left and right interior walls formed with small recess groove portions parallel to the large recess groove portion in an arrangement of facing on the left and right respectively with a cross sectional shape approximately equal to a cross sectional shape of a peripheral end portion of the long side of the light emitting module, and
an interval dimension between facing groove back side portions of the respective small recess groove portions is approximately identical to the dimension of the short side of the light emitting module.

2. The device for supporting a light emitting module according to claim 1, wherein
the small recess groove portions are formed in a rail shape, allowing the peripheral end portion of the long side of the light emitting module to be inserted by sliding from a side face, in left and right interior wall portions of the large recess groove portion.

3. The device for supporting a light emitting module according to claim 1, wherein
the large recess groove portion has a side, closer to an opening than at least the respective small recess groove portions of left and right interior wall portions, formed to be a tapered face of a flat or curved surface becoming wider as getting closer to the opening

4. The device for supporting a light emitting module according to claim 1, wherein
the screw fixation portion is formed by projecting so as to hang out in a direction parallel to an opening plane on an outer side surface on an opening side of the large recess groove portion.

5. The device for supporting a light emitting module according to claim 4, wherein
the supporting device includes a plurality of rows of the large recess groove portions, and
the screw fixation portion is formed in at least one middle portion of the plurality of rows of the large recess groove portions.

6. The device for supporting a light emitting module according to claim 1, wherein
the supporting device has a cross sectional shape that can be formed by extrusion molding in a direction along the large recess groove portion and the respective small recess groove portions.

7. The device for supporting a light emitting module according to claim 1, wherein
on a back surface of the large recess groove portion farther than the respective small recess groove portions, an opening for wiring is formed that passes wiring to supply a power source and a light emission control signal to the light emitting module.

8. The device for supporting a light emitting module according to claim 1, further comprising
a screw to fasten therewith on the ceiling, wherein
the screw has a diameter dimension corresponds to the threaded hole of the screw fixation portion and a length dimension equal to or more than a total dimension of a maximum dimension of combining a depth direction dimension from the screw fixation portion and/or a thickness dimension of the ceiling plate, which is at least a depth direction dimension from the screw fixation portion in the supporting device or more, and a thickness dimension of a component screwed together with the screw.

9. The device for supporting a light emitting module according to claim 8, wherein
the ceiling foundation is a ceiling foundation using a square material of light-gauge steel,
the component screwed together with the screw is an indoor side surface portion of the square material,
a thickness dimension of the component screwed together with the screw is a thickness dimension of the indoor side surface of the square material, and
a length dimension of the screw is a length dimension equal to or more than a total dimension of a dimension from the screw fixation portion to a backmost portion of the supporting device, the thickness dimension of the ceiling plate, and the thickness dimension of the indoor side of the square material.

10. The device for supporting a light emitting module according to claim 8, wherein
the component screwed together with the screw is a mounting component having a fixing portion formed and arranged to enable to press a non-indoor side of the ceiling plate and provided with a threaded hole screwed together with the screw,
the thickness dimension of the component screwed together with the screw is a thickness dimension of the mounting component, and
the length dimension of the screw is a length dimension equal to or more than a total dimension of a dimension from the screw fixation portion to a backmost portion of the supporting device, the thickness dimension of the ceiling plate, and the thickness dimension of the mounting component.

11. The device for supporting a light emitting module according to claim 8, wherein
the ceiling foundation is a ceiling foundation using a square material of light-gauge steel,
the supporting device has a stopper portion formed by projecting so as to hang out in the direction parallel to the opening plane on the outer side surface on the opening side of the large recess groove portion,
the component screwed together with the screw is an indoor side surface portion of the square material,
the thickness dimension of the component screwed together with the screw is a thickness dimension of the indoor side of the square material, and
a length dimension of the screw is a length dimension equal to or more than a total dimension of a dimension from the screw fixation portion to a non-indoor side surface of the ceiling plate and the thickness dimension of the indoor side of the square material.

12. The device for supporting a light emitting module according to claim 8, wherein
the supporting device has a stopper portion formed by projecting so as to hang out in the direction parallel to the opening plane on the outer side surface on the opening side of the large recess groove portion,
the component screwed together with the screw is a mounting component having a fixing portion formed and arranged to enable to press a non-indoor side of the ceiling plate and provided with a threaded hole screwed together with the screw,
at least a long side of the fixing portion is in a dimension larger than an opening width of the ceiling plate in which the large recess groove portion of the supporting device is embedded,
the thickness dimension of the component screwed together with the screw is a thickness dimension of the mounting component, and
a length dimension of the screw is a length dimension equal to or more than a total dimension of a dimension from the screw fixation portion to a non-indoor side surface of the ceiling plate and the thickness dimension of the mounting component.

13. The device for supporting a light emitting module according to claim 8, wherein
the ceiling foundation is a T bar of a system ceiling,
the component screwed together with the screw is a mounting component arranged inside an edge end portion having a part that hangs out sideways of the T bar and formed of a material that can be screwed together with the screw,
the thickness dimension of the component screwed together with the screw is approximately equivalent to a thickness dimension of the mounting component arranged inside the edge end portion, and
a length dimension of the screw is a length dimension approximately equivalent to a total dimension of a dimension from the screw fixation portion to a backmost portion of the supporting device and the thickness dimension of the mounting component.

14. The device for supporting a light emitting module according to claim 13, wherein
the mounting component is in a butterfly nut shape formed inside the edge end portion hanging out sideways of the T bar in a dimension and a shape that can be fixed inside the edge end portion by inserting from an opening in a slit shape on a bottom side of the T bar and making a half turn.
